(19) United States
(12) Patent Application Publication
(10) Pub. No.: US 2006/0232481 A1
(43) Pub. Date: Oct. 19, 2006

(54) Wideband antenna module for the high-frequency and microwave range

(75) Inventor: Achim Hilgers, Alsdorf (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/568,478

(22) PCT Filed: Aug. 17, 2004
(86) PCT No.: PCT/IB04/51471

§ 371 Date: Feb. 15, 2006

(30) Foreign Application Priority Data
Aug. 21, 2003 (EP) 03102614.9

(51) Int. Cl. H01Q 1/24

(52) U.S. Cl. 343/702; 343/895

(57) ABSTRACT

An antenna module more particularly for the high-frequency and microwave range is described which can be operated as a wideband antenna in various frequency bands. For this purpose the antenna module is particularly suitable in that it has an antenna (10) and an HF line (20) to connect the antenna (10) to associated transmit and/or receive stages, while at least parts or sections (21, 22) of the HF line (20) have a mismatch in the form of an impedance deviating from that of the antenna (10). The invention also relates to a telecommunications device having such an antenna module.

The invention relates to an antenna module, more particularly for the high-frequency and microwave range, which can be operated in the wideband or various frequency bands respectively. The invention also relates to a telecommunications device comprising such an antenna module.

For transmitting information by particularly mobile telecommunications devices, generally electromagnetic waves are used in the high-frequency or microwave range. For transmitting and receiving these waves antennas are increasingly used which can be operated in various frequency bands each having a respective sufficiently large bandwidth.

Such frequency bands are situated for example in the mobile telephone standard between 880 and 960 MHz (GSM 900), between 1710 and 1880 MHz (GSM or DCS 1800), as well as particularly in the USA between 824 and 894 MHz (AMPS), as well as 1850 and 1990 MHz (D-AMPS, PCS or GSM 1900). Furthermore, this includes the UMTS band (1880 to 2200 MHz), more particularly wideband CDMA (1920 to 1980 MHz and 2110 to 2170 MHz) as well as the DECT standard for cordless telephones in the frequency band from 1880 to 1900 MHz and the Bluetooth standard (BT) in the frequency band between 2400 to 2483.5 MHz which is used for exchanging data between various electronic devices such as, for example, mobile telephones, computers, appliances using entertainment electronics etc.

It is also necessary at least in a time-dependent transition area for mobile telephones to be operated both in at least one of the GSM frequency ranges and in the UMTS frequency range. In many cases it is also necessary for a mobile telephone to be operable both in the two European (GSM) bands and in the two US bands (AMPS and PCS), so that users who are often in the USA and in Europe need not carry along two mobile telephones.

In addition to the transmission of information, the mobile telecommunications devices are also partly provided with additional functions and applications such as, for example, for the satellite navigation in the known GPS or another frequency range in which the antenna should then also be capable of operating.

Basically, it is necessary for modern telecommunications devices of this type to be operable in a maximum number of these frequency ranges, so that corresponding multiband or wideband antennas are necessary which cover these frequency ranges.

Due to the increasing integration of these and further functions in a mobile telephone and the simultaneous attempts to miniaturize them as much as possible, there is a further need for the antennas to have the smallest possible volume and a smallest possible surface because there is ever less space in the housings available.

In order to minimize the size of the antenna with a given wavelength of the emitted radiation, a dielectric having a dielectric constant εᵣ>1 can be used. This leads to a shortening of the wavelength of the radiation in the dielectric by a factor of 1/⊂εᵣ. Therefore, an antenna designed on the basis of such a dielectric is also reduced by this factor. But a disadvantage of this is that with an increasing dielectric constant also the bandwidth of the antenna becomes accordingly smaller.

An antenna of this kind comprises a substrate of a dielectric material on the surfaces of which one or more resonant metallization structures are applied as dictated by the desired frequency band or bands. The values of the resonant frequencies depend on the dimensions of the printed metallization structures and the value of the dielectric constant of the substrate. The values of the individual resonant frequencies then become lower as the length of the metallization structures increases and as the values of the dielectric constant become higher. Antennas of this kind are also referred to as Printed Wire Antennas (PWA) or Dielectric Block Antennas (DBA).

A particular advantage of such antennas is that they, together with other components as desired, can be mounted directly on a printed circuit board (PCB) by the surface-mounting (SMD) technique i.e. by being soldered flat to the board and by contacts being made in the same way, without any additional mountings (pins) being required to feed in the electromagnetic power.

Problematic and difficult, however, may be the dimensioning of the metallization structures particularly when such an antenna is to operate in a plurality of frequency bands. An optimum adaptation of the antenna to one of the required frequency ranges results in that the antenna power in the other frequency ranges is affected because the metallization structures affect each other.

Another type of antenna which is also used in mobile telecommunications devices are the what are called Planar Inverted F Antennas (PIFA) in which a metallization structure is disposed over a ground metallization, and which work as volume resonators. Detriments to these antennas are, however, that they either need relatively much space, which can be reduced only to a limited extent by the use of dielectric materials, or that they have only a very narrow bandwidth in case of a reduced size on account of the strong interaction between different parts of the metallization structure.

An object on which the invention is based therefore consists in that an antenna is provided particularly for the high-frequency and microwave range, which antenna, compared to the known antennas, has a considerably wider resonance curve for the frequency ranges mentioned above.

More particularly an antenna module is to be provided which is operable in at least two of the above-mentioned frequency ranges.

Furthermore, with the invention an antenna module of the type defined in the opening paragraph should be provided which can be accommodated in a relatively small mobile telecommunications device that has a relatively large resonance bandwidth and relatively small dimensions and is thus saving space.

The object is achieved in accordance with claim 1 by an antenna module having an antenna and an HF line to connect the antenna to associated transmit and/or receive stages in which at least parts or sections of the HF line have a mismatch in the form of an impedance that deviates from the impedance of the antenna.

A particular advantage of this solution consists in that no additional components or assemblies such as, for example, passive impedance interface networks or active controls are necessary which both take up space on the printed circuit board and would also cause additional costs.

A further advantage of the solution consists in that it can be applied largely independently of the type of antenna used and the operating frequency range provided. In this way, more particularly also the different types of high-frequency and microwave antennas mentioned in the opening paragraph can be given a larger resonance bandwidth.

The dependent claims have advantageous further embodiments of the invention.

The embodiments as defined in claims 2 and 3 result in a particularly effective increase of the resonance bandwidth.

The embodiments as defined in claims 4 and 5 comprise an antenna which can be particularly advantageously used in the antenna module according to the invention.

The embodiment in accordance with claim 5 additionally offers itself particularly well for operating frequencies of about 2 GHz and over and has the further advantage that a substrate may be dispensed with.

The claims 6 and 7 finally relate to a printed circuit board or a mobile telecommunications device respectively having an antenna module in accordance with the invention.

Further details, characteristics and advantages of the invention are apparent from the following description of exemplary embodiments of the invention with reference to the drawing, in which:

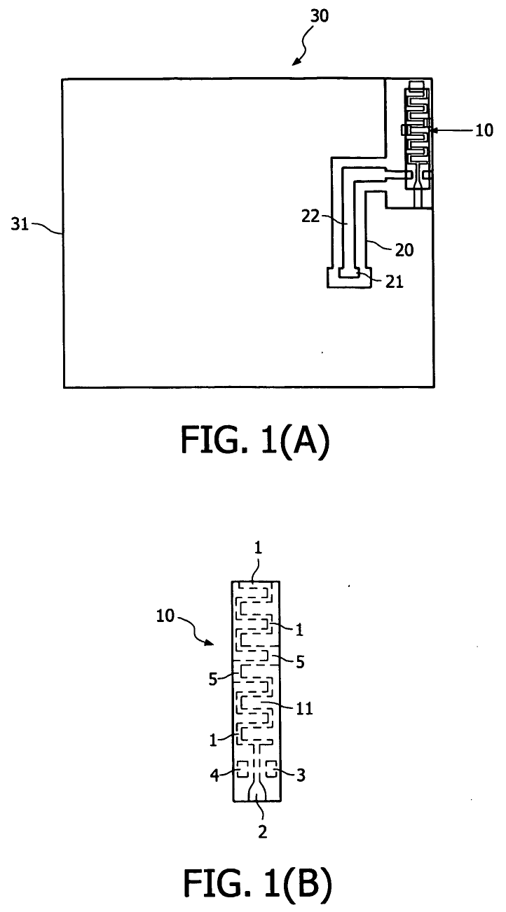

FIG. 1A shows a diagrammatic plan view of a printed circuit board with an antenna module according to the invention,

FIG. 1B is an enlarged representation of an antenna of the antenna module,

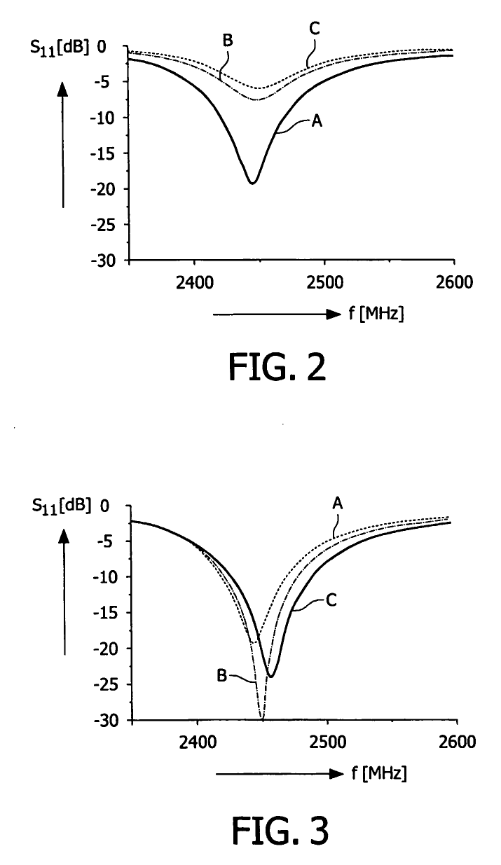

FIG. 2 shows the curves of the scattering parameters of the antenna module with input structures of reduced impedance;

FIG. 3 shows the curves of the scattering parameters of the antenna module having input structures of increased impedance,

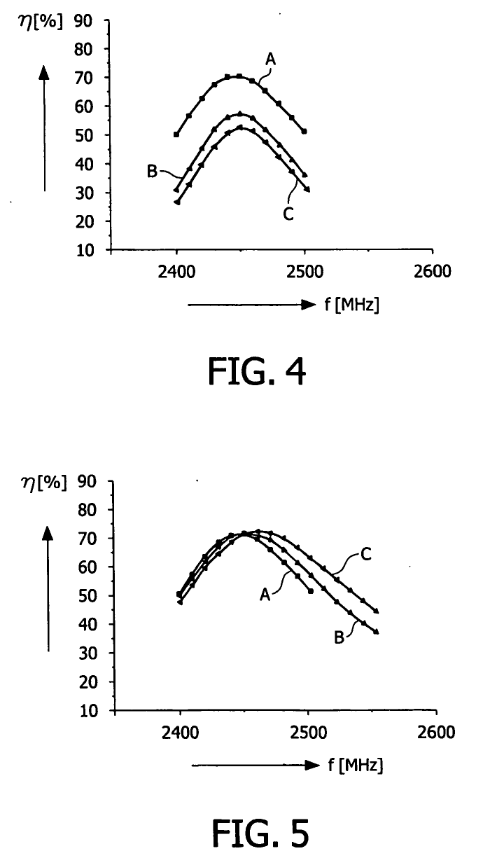

FIG. 4 shows the curves of the efficiency of the antenna module with input structures having reduced impedance; and

FIG. 5 shows the curves of the efficiency of the antenna module with input structures having increased impedance.

FIG. 1(A) is a diagrammatic plan view of the front of a printed circuit board (PCB) 30 having a metallization 31 which is preferably provided on its rear side. In a corner of the printed circuit board 30 in which there is no metallization 3 1, there is an antenna module having an antenna 10 and an HF line 20.

The antenna 10 is shown in enlarged form in FIG. 1(B) for clarity. This is a dielectric block antenna (DBA) or printed wire antenna (PWA). The antenna module according to the invention, however, can also be produced with other types of antennas, more particularly as explained earlier. Furthermore, the module can be dimensioned not only for the frequency ranges to be mentioned hereinafter, but also for other frequency ranges such as those described earlier.

The antenna 10 comprises a substrate 11 which, in essence, has the form of a cuboidal block whose length or width is larger than its height by a factor of about 3 to 40. Therefore, in the following description the upper (large) face of the substrate 11 in the representation of FIG. 1 is to be referred to as upper main face, the opposite face as lower main face and the surfaces perpendicular thereto as side faces of the substrate 11.

Instead of a cuboidal substrate 11 is also possible to select another geometrical form such as, for example, a round or triangular or quadrangular cylindrical form depending on the application and available space. Furthermore, the substrate 11 may also have a hollow space or recesses to save on, for example material and thus weight.

The substrate 11 is made of, for example, a ceramic material and/or one or more plastics that can be used with high frequencies or by embedding a ceramic powder in a polymer matrix. It is also possible to use pure polymer substrates. The materials should have the least possible losses and a slight temperature dependence of the high-frequency properties (NPO or so-called SL materials).

In order to reduce the size of the antenna 10, the substrate 11 preferably has a dielectric constant of εᵣ>1 and/or a relative permeability of μᵣ>1. But it should be considered in this respect that the bandwidth that can be achieved with substrates having a large or increasing dielectric constant and/or relative permeability diminishes.

With the antenna 10 shown in FIG. 1(B) the substrate 11 (preferably NPO ceramic) has a dielectric constant εᵣ of about 21.5 and a length of about 10 mm, a width of about 2 mm and a height of about 1 mm. The antenna is suitable for wireless communication in the 2.4 GHz ISM band (for example Bluetooth, WLAN, home RF etc.).

The substrate 11 carries on its lower main face a resonant printed wiring structure 1 of an electrically highly conductive material such as, for example, silver, copper, gold, aluminum or a superconductor. The printed wiring structure 1 could also be embedded in the substrate 11.

On the lower main face of the substrate 11 is disposed a first resonant metallization structure 1 (dotted line) which is connected via a first connecting point 2 (solder point) to a ground potential i.e. ground metallization 31. The metallization structure 1 may be formed by one or various individual metallizations in the form of printed wiring of different widths as the case may be. In the embodiment shown the structure has in essence a meandering form over the entire length of the substrate 11 and has an electrically effective length L′ of L/⊂εᵣ where L is the wavelength of the signal in free space. The metallization structure 1 is measured such that its length corresponds to about half the wavelength with which the antenna is to radiate electromagnetic power. For example, for the application of the antenna module in the frequency range mentioned above between 2400 and 2483.5 MHz there is a wavelength L of about 12.5 cm in free space. With a dielectric constant ?ᵣ of the substrate of 21.5 the half wavelength 0.5 L′ is shortened, and thus the necessary geometric length of the metallization structure 1, to about 13.48 mm.

The resonant metallization structure 1 could also be embedded in the substrate 11 or be located on the upper main face of the substrate 11 with equivalent contacting.

Additional to the resonant metallization structure 1 there are at least two further metallization structures on the lower main face of the substrate 11, which serve as feeding points 3, 4 for capacitively coupling-in the HF power to be radiated.

In accordance with FIG. 1(B) they are a first feeding point 3 as well as a second feeding point 4, which in the area of the first connecting point 2 are arranged on opposite edges of the lower main face of the substrate 11 in symmetry with the longitudinal axis of the substrate 11. The feeding points 3, 4 then preferably have a distance of about 200 μm from the edge of the substrate 11 for reasons associated with the manufacturing. The feeding points 3, 4 are soldered onto corresponding contact points of the printed circuit board 30 as is the first connecting point 2.

The selection of the feeding point 3, 4 for coupling-in the HF power is made in dependence on the positioning of the antenna on the printed circuit board 30 concerned.

To improve mechanical load-bearing capacity in case the printed circuit board 30 is for example bent, and to ensure reliable contact, the soldering points 5 are further arranged on the lower main face in the region of the opposite longitudinal end of the substrate 11.

As an alternative to the substrate antenna described above it is possible to dispense with the substrate particularly with frequencies of about 2 GHz and over and to dispose the antenna i.e. the resonant printed wiring structure, for example directly on the printed circuit board 30 and to establish the HF connection via capacitive coupling mechanisms, for example, an SMD capacitor on the printed circuit board 30. Since the material of the printed circuit board 30 generally has a dielectric constant of 4, but also materials for the printed circuit board having a dielectric constant of about 10 are known, the resonant printed wiring structure needs to be modified only marginally, in particular be lengthened.

Antennas of this and similar types are generally arranged such that they have an input impedance of 50 Ohms. Normally, also the HF line to connect the antenna to the transmit and receive stages has a self-impedance or a line impedance of 50 Ohms to achieve as reflection-free and thus loss-free adaptation as possible between antenna, HF line and the electronic units connected thereto (final stages, receiving stages etc.). However, also other antenna and line impedances are conceivable.

In the case of the antenna module according to the invention the HF line 20 is arranged, for example, as a co-planar line or printed wiring on the printed circuit board 30. Other embodiments such as, for example, microstrips, strip lines etc. are also possible, however.

The self-impedance of these HF lines 20 can be adjusted by suitable selection of certain parameters such as, for example, their physical dimensions, more particularly their width, their distance from the ground metallization 31 of the printed circuit board 30 and the type and thickness of the material (dielectric constant) used for the printed circuit board 30.

According to the invention the selection of these parameters is made so that at least parts or sections 21, 22 of the HF line 20 have a mismatch, which means an impedance deviating from the self-impedance of the antenna 10. Surprisingly it has appeared that the bandwidth of the whole antenna module can be considerably enlarged by this.

The bandwidth of the antenna module can then specifically be adjusted by the selection of the extent of the impedance deviation where the impedance of the HF line 20 may be larger or smaller than the impedance of the antenna 10.

There is a particularly strong increase of the resonance bandwidth of the antenna module when in the course of the HF line 20 an impedance transgression or impedance jump, i.e. a relatively steep change of the impedance, is inserted.

In accordance with FIG. 1(A) such an impedance jump can be achieved, for example in that a first HF line section 21 adjusted to the input impedance of the antenna 10 is connected to the antenna 10 via a second section 22 whose line impedance compared to the input impedance of the antenna 10 is about 10 to 25% higher or lower, so that all in all there will be an HF line 20 mismatch with the antenna.

The FIGS. 2 and 3 show the influence of a mismatched HF line 20 on the resonance bandwidth of the antenna module shown in FIG. 1(A), where the antenna 10 has a self-impedance of 50 Ohms. In the FIGS. 2 and 3 the scattering parameters S₁₁ are plotted against frequency.

In FIG. 2 the resonance curve A shows the case of an adjusted 50 Ohm HF line for comparison. The resonance curve B shows the case of an HF line 20 having a self-impedance of 40 Ohms, whereas the resonance curve C was measured for an impedance jump in the HF line 20 from 50 to 40 Ohms (for example by means of the two line sections 21, 22 shown in FIG. 1(A)).

In FIG. 3 the resonance curve A again shows the case of a matched 50-Ohm HF line for comparison. The resonance curve B appears in the case of an HF line 20 having an impedance of 60 Ohms, whereas the resonance curve C was measured for an impedance jump in the HF line 20 from 50 to 60 Ohms (which can again for example be realized by means of the two line sections 21, 22 shown in FIG. 1(A)).

A comparison of the two FIGS. 2 and 3 more particularly of the resonance curves B shows that the resonance bandwidth can be considerably increased by an impedance increase to 60 Ohms, whereas there was a reduction of the resonance bandwidth for the antenna shown in FIG. 1(B) when there was an impedance reduction to 40 Ohms. However, it is possible with different antenna designs, for example, such designs having impedances different from 50 Ohms, to achieve an increase of the resonance bandwidth even when an HF line 20 is used with reduced impedance compared therewith.

The inclusion of an impedance transition or impedance jump results in the largest resonance bandwidth for the antenna 10 shown in FIG. 1(B) as shown in the resonance curve 3 in FIG. 3.

The FIGS. 4 and 5 show the effects of the antenna module with the various HF lines plotted against frequency.

FIG. 4 shows in curve A the variation of the efficiency in the case of a 50-Ohm HF line adapted to the antenna 10. The efficiency shown in curve B is the result of a mismatched HF line 20 with a self-impedance of 40 Ohms, whereas curve C shows the variation of the efficiency in the case of an HF line 20 with an impedance jump from 50 to 40. For the antenna 10 shown in FIG. 1(B) there was a lower efficiency in the case of an HF line 20 having an impedance that was reduced compared to that of the antenna.

FIG. 5 correspondingly shows the efficiency curves in the case of a mismatch by impedance increase, that is to say compared to the curve A which is again used for an adapted 50 Ohm HF line.

Curve B shows the case of an impedance increase to 60 Ohms whereas the curve C shows the efficiency variation for an HF line 20 with an impedance jump from 50 to 60 Ohms.

FIG. 5 shows that, as a result of the increase of the impedance of the HF line 20 compared to that of the antenna 10, the efficiency even improves so that the increase of the resonance bandwidth is not caused by additional losses such as, for example, by reflection.

The curves B and C in FIG. 5 illustrate that also the radiation bandwidth is considerably higher when an HF line 20 is used with 60 Ohms and particularly such an HF line is used with an impedance transition from 50 to 60 Ohms. The bandwidth was thereby increased by about 30 MHz, which corresponds to a proportional widening by about 30%.

The above values of the line impedances are to be understood merely as examples. Obviously, also mismatches with different impedance values than in the order of magnitude mentioned above of about 10 to about 25% may be effected while the selection and design in essence depends on the type of antenna, the frequency range provided and the desired bandwidth.

1. An antenna module, more particularly for the high-frequency and microwave range with an antenna (10) and an HF line (20) to connect the antenna (10) to associated transmit and/or receive stages, in which at least parts or sections (21, 22) of the HF line (20) have a mismatch in the form of an impedance deviating from the impedance of the antenna (10).

2. An antenna module as claimed in claim 1, comprising an HF line (20), which has an impedance that is about 10 to about 25% lower or higher than that of the antenna (10).

3. An antenna module as claimed in claim 1, comprising an HF line (20) which has a first and a second section (21, 22) which have different impedances and form an impedance transition or impedance jump which is about 10 to about 25% lower or higher than the self-impedance of the antenna (10).

4. An antenna module as claimed in claim 1, in which the antenna (10) is a dielectric block antenna (DBA) or a printed wire antenna (PWA) which is mounted on a printed circuit board (30), in which the HF line (20) is produced in the form of at least one printed wiring structure deposited on the printed circuit board (30).

5. An antenna module as claimed in claim 1, in which the antenna is produced in the form of at least one resonant printed wiring structure and is deposited on a printed circuit board (30) together with the HF line (20).

6. A printed circuit board, more particularly for surface mounting electronic elements, comprising an antenna module as claimed in claim 1.

7. A mobile telecommunications device, more particularly for the 2.4-GHz range, comprising an antenna module as claimed in claim 1.
